(19) United States
(12) Patent Application Publication
(10) Pub. No.: US 2020/0340364 A1
(43) Pub. Date: Oct. 29, 2020

(54) TURBINE WHEEL ASSEMBLY WITH CERAMIC MATRIX COMPOSITE BLADES

(71) Applicants: Rolls-Royce Corporation, Indianapolis, IN (US); Rolls-Royce North American Technologies Inc., Indianapolis, IN (US)

(72) Inventors: Shaling Starr, Fishers, IN (US); Aaron D. Sippel, Zionsville, IN (US); Ted J. Freeman, Danville, IN (US)

(21) Appl. No.: 16/396,194

(22) Filed: Apr. 26, 2019

(51) Int. Cl. F01D 5/30; F01D 5/10

(52) U.S. Cl. CPC F01D 5/3084; F01D 5/3007; F05D 2260/96; F05D 2220/32; F01D 5/10

(57) ABSTRACT

A turbine blade comprising ceramic matrix composite materials and designed for incorporation into a turbine wheel assembly is disclosed in this paper. Further disclosed are features for managing stiffness and dampening in order to influence vibratory response of such a turbine blade when used as part of a turbine wheel assembly in a gas turbine engine.

### FIELD OF THE DISCLOSURE

The present disclosure relates generally to turbine engine components comprising ceramic matrix composites, and more specifically to rotating component assemblies with components made from ceramic matrix composites.

### BACKGROUND

Gas turbine engines are used to power aircraft, watercraft, power generators, and the like. Gas turbine engines typically include a compressor, a combustor, and a turbine. The compressor compresses air drawn into the engine and delivers high pressure air to the combustor. In the combustor, fuel is mixed with the high pressure air and is ignited. Products of the combustion reaction in the combustor are directed into the turbine where work is extracted to drive the compressor and, sometimes, an output shaft. Left-over products of the combustion are exhausted out of the turbine and may provide thrust in some applications.

Compressors and turbines typically include alternating stages of static vane assemblies and rotating wheel assemblies. The rotating wheel assemblies include disks carrying blades around their outer edges. In some designs, the blades may be made from ceramic matrix composite materials suited to use in high temperature environments. These materials have material properties different from metallic materials that had been used in blades in earlier designs. When the rotating wheel assemblies turn, centrifugal and dynamic forces act on the blades and designs managing these forces, while taking into account the material properties of ceramic matrix composites, are an area of continued interest.

### SUMMARY

The present disclosure may comprise one or more of the following features and combinations thereof.

A turbine wheel assembly adapted for use in a gas turbine engine is disclosed herein. The assembly illustratively includes a disk, a plurality of turbine blades made from ceramic matrix composite materials, and a plurality of platforms independent of the turbine blades. The disk is configured for rotation about an engine axis and shaped to include a plurality of dovetail slots spaced about the periphery of the disk. The plurality of turbine blades are each shaped to include (i) an airfoil that extends radially away from the disk and (ii) a root with a dovetail shape that is received in one of the plurality of dovetail slots spaced about the periphery of the disk to couple the turbine blade to the disk for rotation with the disk. The plurality of platforms are configured to resist the movement of hot gases that interact with the airfoils of the plurality of turbine blades from moving radially-inwardly toward interaction with the roots of the plurality of turbine blades.

In illustrative embodiments, each of the plurality of turbine blades is shaped so that the root with the dovetail shape of each turbine blade includes pockets formed therein. The pockets are formed at a location radially inward of a minimum thickness section of the root to allow for adjustment of the natural frequency of the turbine blade away from undesired modes.

In illustrative embodiments, the pockets include face pockets formed in an axially-facing forward surface of the root and in an axially-facing aft surface of the root. The assembly may further include a plurality of isolation shims configured to discourage material interaction between the plurality of turbine blades and the disk at the point of loading along the root during rotation of the turbine wheel assembly about the engine axis. The plurality of isolation shims can include primary panels arranged to interface between radially-outwardly facing load surfaces of the root and radially-inwardly facing load surfaces of the disk that define the dovetail slots and retention arms that extend into the pockets formed in the axially-facing forward surface of the root and the axially-facing aft surface of the root.

In illustrative embodiments, the pockets include side pockets formed in at least partially radially-outwardly facing load surfaces of the root. The assembly can further include a plurality of loose fill pieces each arranged in one of the side pockets for movement relative to the plurality of turbine blades. Each of the side pockets can be shaped to extend at least in part radially-outwardly from an opening in the radially-outwardly facing load surfaces of the root so as to encourage movement of the plurality of loose fill pieces into contact with the root upon rotation of the turbine wheel assembly about the engine axis.

In illustrative embodiments, the assembly can include a plurality of isolation shims configured to discourage material interaction between the plurality of turbine blades and the disk at the point of loading along the root during rotation of the turbine wheel assembly about the engine axis. The plurality of isolation shims may include primary panels arranged to interface between the radially-outwardly facing load surfaces of the root and radially-inwardly facing load surfaces of the disk that define the dovetail slots, and wherein the primary panels block movement of the plurality of loose fill pieces out of the side pockets.

In illustrative embodiments, the pockets can include face pockets formed in an axially-facing forward surface of the root and in an axially-facing aft surface of the root. In some such embodiments, the plurality of isolation shims include retention arms that extend into the face pockets to retain the primary panels in place relative to the plurality of turbine blades.

According to another aspect of the present disclosure, a turbine wheel assembly adapted for use in a gas turbine engine is contemplated. The assembly Can include a disk, a plurality of turbine blades comprising ceramic matrix composite materials, and a plurality of platforms. The disk may be configured for rotation about an engine axis and may be shaped to include a plurality of slots spaced about the periphery of the disk. The plurality of turbine blades can each be shaped to include an airfoil that extends radially away from the disk and a root that is received in one of the plurality of slots spaced about the periphery of the disk to couple the turbine blade to the disk for rotation with the disk. The plurality of platforms can be independent of the plurality of turbine blades and may be are coupled to the disk for rotation with the disk about the engine axis.

In illustrative embodiments, each of the plurality of turbine blades is shaped so that the root of each turbine blade includes pockets formed therein at a location radially inward of a minimum thickness section of the root. The pockets can include face pockets formed in at least one of an axially-facing forward surface of the root and in an axially-facing aft surface of the root.

In illustrative embodiments, the assembly may include a plurality of isolation shims located between the plurality of turbine blades and the disk at a point of radial loading along the root during rotation of the turbine wheel assembly about the engine axis. The plurality of isolation shims can include (i) primary panels arranged to interface between radially-outwardly facing load surfaces of the root and radially-inwardly facing load surfaces of the disk and (ii) retention arms that extend into the face pockets formed in the root.

In illustrative embodiments, the pockets can include side pockets formed in at least partially radially-outwardly facing load surfaces of the root. In some such embodiments, a plurality of loose fill pieces can each be arranged in one of the side pockets for movement relative to the plurality of turbine blades. Each of the side pockets can be shaped to extend, at least in part, radially-outwardly from an opening into the root so as to encourage movement of the plurality of loose fill pieces radially outwardly upon rotation of the turbine wheel assembly about the engine axis.

In illustrative embodiments, the assembly may further include a plurality of isolation shims located between the plurality of turbine blades and the disk at the point of radial loading along the root during rotation of the turbine wheel assembly about the engine axis. The plurality of isolation shims can include primary panels that interface between the root and the disk. The primary panels can block movement of the plurality of loose fill pieces out of the side pockets.

In illustrative embodiments, the pockets may include face pockets formed in an axially-facing forward surface of the root and in an axially-facing aft surface of the root. In some such embodiments, the plurality of isolation shims include retention arms that extend into the face pockets.

These and other features of the present disclosure will become more apparent from the following description of the illustrative embodiments.

### BRIEF DESCRIPTION OF THE DRAWINGS

FIG. 1 is a perspective view of a portion of a turbine wheel assembly showing that the assembly includes a metallic disk, a plurality of turbine blades comprising ceramic matrix composite materials that are coupled to the disk around the outer periphery of the disk, and a plurality of platforms coupled to the disk around the outer periphery of the disk that block gasses interacting with airfoils of the turbine blades from moving toward attachment roots of the turbine blades;

FIG. 2 is an exploded perspective assembly view of the portion of a turbine wheel assembly from FIG. 1 showing that the root of the turbine blades has a dovetail shape with pockets formed therein to allow for adjustment of the natural frequency of the turbine blade, and further showing that the turbine wheel assembly can optionally include isolation shims that can extend into face pockets at forward/aft sides of the root to locate the isolation shims relative to a corresponding turbine blade and/or optional loose material arranged in certain pockets;

FIG. 3 is a detail perspective view of a root of a turbine blade included in the assemblies of FIGS. 1 and 2 showing that the root illustratively includes pockets formed in axially-facing forward/aft surfaces of the root and pockets formed in circumferentially-facing side surfaces of the root; and

FIG. 4 is a detail elevation view of the root of the turbine blade of FIG. 3 showing that pockets formed in circumferentially-facing side surfaces of the root can be shaped to extend radially-outwardly as they extend into the root of the blade so as to retain loose material placed in the pockets upon rotation of the turbine blade about an engine axis.

### DETAILED DESCRIPTION OF THE DRAWINGS

For the purposes of promoting an understanding of the principles of the disclosure, reference will now be made to a number of illustrative embodiments illustrated in the drawings and specific language will be used to describe the same.

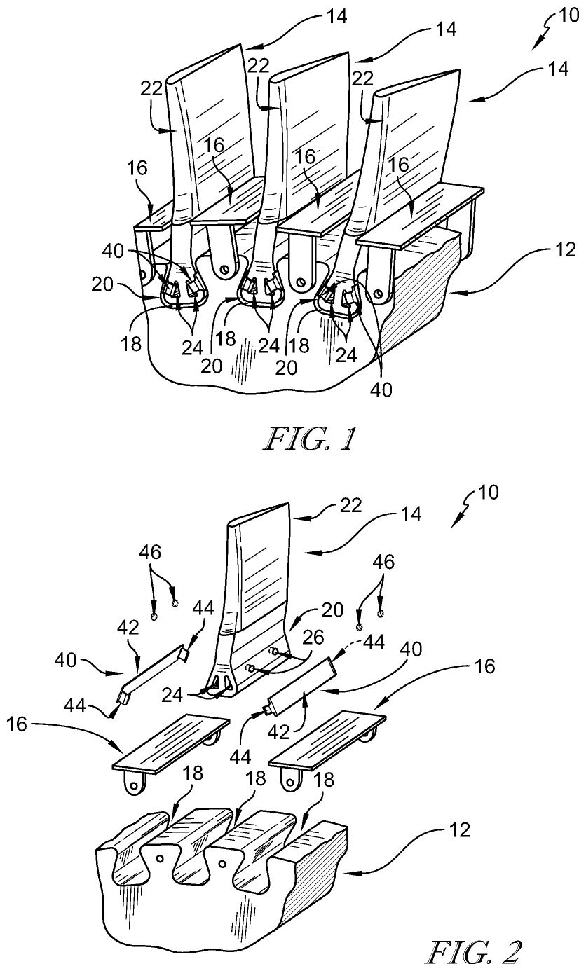

A turbine wheel assembly 10, as shown in-part in FIG. 1, is adapted for use in a gas turbine engine in which the turbine wheel assembly 10 rotates about a reference engine axis. The assembly 10 illustratively includes a disk 12, a plurality of turbine blades 14, and a plurality of platforms 16. The disk 12 is made from metallic materials and is formed to include attachment slots 18 arranged around its circumference. The turbine blades 14 are made from ceramic matrix composite materials adapted for use at high temperature that are coupled to the disk 12 via the attachment slots 18. The platforms 16 are independent of the turbine blades 14 and are coupled to the disk 12 around the outer periphery of the disk 12.

The turbine blades 14 interact with hot gases to drive rotation of the turbine wheel assembly 10 during use of the turbine wheel assembly 10 in an engine. Each turbine blade 14 is shaped to provide a root 20 and an airfoil 22 as shown in FIGS. 1 and 2. The root 20 is received in an associated attachment slot 18 to couple the turbine blade 14 to the disk 12. The airfoil 22 extends out from the outer circumference of the disk 12 and is shaped to interact with hot gasses moving through the primary gas path of an associated gas turbine engine.

The root 20 of each turbine blade 14 illustratively has a dovetail shape that corresponds to the shape of corresponding attachment slots 18 as shown in FIG. 2. Other suitable shapes for the root 20, such as fir tree, T-shape, and other suitable shapes are also contemplated. The root 20 also includes pockets 24, 26 formed therein at locations radially inward of a minimum thickness section 28 of the root 20. These pockets 24, 26 are configured to adjust the natural frequency of the turbine blade 14 away from undesired vibration modes that might be induced during use of the turbine wheel assembly 10 in a gas turbine engine.

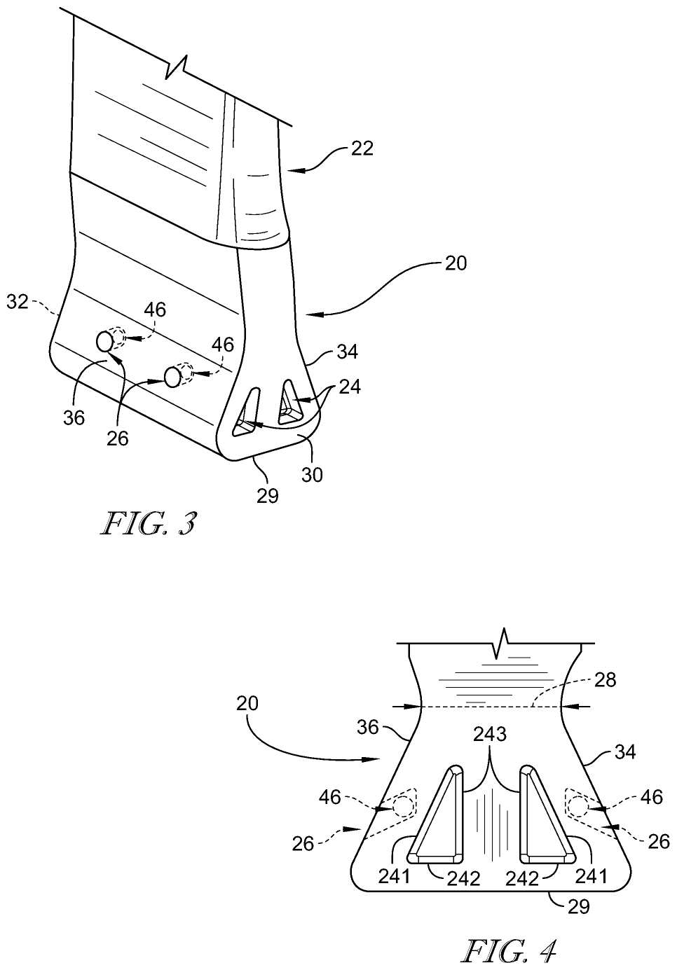

In the illustrated embodiment, the root 20 includes face pockets 24 and side pockets 26 as shown in FIGS. 2-4. The face pockets 24 are formed in an axially-facing forward surface 30 of the root 20 and in an axially-facing aft surface 32 of the root 20. The side pockets 26 formed in primarily circumferential side surfaces 34, 36 of the root 20 that provide at least partially radially-outwardly facing load surfaces of the root 20. While only two pockets 24, 26 are shown in each surface, fewer or greater numbers of pockets may be used. In addition, bottom pockets (not shown) may be formed in a bottom surface 29 of the root 20 and may extend partway into the root 20 short of the minimum thickness region 28. Pockets 24, 26 can be created in the forming/casting of the turbine blade 14 or through machining operations after the thick CMC forming attachment root 20 is made.

The face pockets 24 extend only part-way into the root 20 and in the shown embodiment have a triangular shape when viewed in an axial direction as shown in FIG. 4. A first side 241 of each face pocket 24 is parallel, or substantially parallel, to a primarily circumferential side surface 34, 36 of the root 20. A second side 242 of each face pocket 24 is parallel, or substantially parallel, to a bottom surface 29 of the root 20. A third side 243 of each face pocket 24 is parallel, or substantially parallel, to the third side 243 of another face pocket 24 formed in the same root 20. Of course other shapes are contemplated for face pockets 24, such as rectangular, round, polygonal etc. Moreover, other depths of face pockets 24 may be selected. In some embodiments, the face pockets 24 can be angled and extend radially outwardly from the associated apertures in the root 20 surface.

The side pockets 26 extend only part-way into the root 20 and illustratively have a round cross-sectional shape as shown in FIGS. 2-4. Each of the side pockets 26 are shaped to extend at least in part radially-outwardly from an associated opening in the primarily circumferential side surfaces 34, 36 of the root 20. Of course other shapes are contemplated for side pockets 26, such as rectangular, triangular, polygonal etc. Moreover, other depths of the side pockets 26 may be chosen.

The turbine wheel assembly 10 may optionally include a plurality of isolation shims 40 as shown in FIGS. 1 and 2. The isolation shims 40 are configured to discourage material interaction between the plurality of turbine blades 14, made from ceramic matrix composite, and the disk 12, made of metallic materials. In particular, the isolation shims 40 can block the migration of material constituents of both the disk 12 and CMC blade 14 into the other component. The shims also inhibit the formation of low melting point phases that could result from diffusion into each component. In addition, the isolation shims 40 can act as dampers for deadening vibration of the turbine blades 14 relative to the disk 12.

Each isolation shim 40 is made from metallic materials and may be a constant thickness component made from sheet of base material as suggested in FIG. 2. The isolation shims 40 each include a primary panel 42 and retention arms 44 that extend from the primary panel 42. The primary panel 42 is arranged to interface between primarily circumferential side surfaces 34, 36 of the root 20 and radially-inwardly facing load surfaces of the disk 12 that define the slots 18 that have a dovetail shape. The retention arms 44 extend into the face pockets 24 formed in the axially-facing surfaces 30, 32 of the root 20. The retention arms 44 are illustratively shaped to hold an associated isolation shim 40 in place relative to the root 20 so that the primary panel 42 is located as desired.

In some embodiments, other retention arms may be used with the primary panel 42 that extend to retain the isolation shim 40 in place. For example, such other retention arms may extend into or otherwise interact with side pockets 26 or other pockets that extend into the root 20.

Turbine wheel assembly 10 may optionally include loose fill pieces 46 each arranged in the side pockets 26 as suggested in FIGS. 2-4. The loose fill pieces 46 may be free for movement in their corresponding side pocket 26 relative to the turbine blades 14. The loose fill pieces 46 can dampen vibration of the turbine blades 14 when the turbine wheel assembly 10 is rotated. The side pockets 26 shape that extends at least in part radially-outwardly the corresponding opening can encourage movement of the loose fill pieces 46 into contact with the root 20 upon rotation of the turbine wheel assembly 10. Further, in embodiments, including the isolation shims 40, the primary panel 42 of an isolation shim 40 can extend over the opening into the side pockets 26 to block movement of the loose fill pieces 46 out of the side pockets 26.

In some embodiments, optional loose fill pieces 46 may be placed in face pockets 24 and/or in pockets that extend into the root 20 from a radially-inwardly facing surface of the root 20. Moreover, in some embodiments, cover plates may be used with loose fill pieces 46 in any pocket to cover associated apertures and block movement of the loose fill pieces 46 out of the pockets. Cover plates can be made from a variety of materials including ceramic matrix composites, monolithic ceramics, metallics, or other materials. The cover plates may be coupled to the root 20 via ceramic matrix material, braze layer(s), and or any other suitable coupling.

The platforms 16 of the illustrated design are independent of the turbine blades 14 as shown in FIGS. 1-2. The platforms 16 block gasses interacting with airfoils 22 of the turbine blades 14 from moving toward attachment roots 20 of the turbine blades 14. The platforms 16 are illustratively pinned to lugs 17 included in the disk 12 that define the attachment slots 18. Dampers and/or seals may be arranged between the platforms 16 and the turbine blades 14.

It is noted that as ceramic matrix composites (CMC) materials and designs mature, they will be used in turbine blade applications like turbine blade 14 disclosed herein. This is potentially where the greatest benefit exists for implementing CMC in gas turbine engines can be realized. In addition to the CMC being capable of operating at higher temperatures and deliver cooling air savings/SFC reductions to the system, the weight reductions provided over a metallic blade system are significant. Not only are the blades lighter, but these savings are multiplied since the size and weight of the disks (e.g. disk 12) may be reduced.

The CMC material allows the weight of the blades 14 to be lower in weight, however there can also be a reduction in strength. This reduction in strength can present challenges in providing the platform (inner annulus feature) as an integral feature to the rest of the blade (airfoil, stalk, attachment). The added centrifugal (Cf) load from an integral platform can pushes the stresses in the CMC blade attachment above the material allowables. Therefore, the concepts disclosed herein for a CMC blade 14 do not have an integral platform, but instead an offloaded metallic platform 16. The offloaded platform 16 is carried directly by the disk 12 reducing the amount of load that needs to be carried through the CMC blade attachment 20. While incorporation of a platform into a CMC blade is contemplated, it is not illustrated and may not be desirable in all configurations.

In reducing the steady state stresses by offloading the platform, another challenge can arise. The dynamic response of a blade can be mitigated by friction dampers (among other methods) located between blade platforms. Without an integrated platform a novel approach to damping may be desirable. Alternatively, the blade design can be changed to modify/tune the effective stiffness of the blade to keep dynamic mode crossings out of the engine operating range. Embodiments of turbine blades 14 used within turbine wheel assemblies 10 provide some examples of how the stiffness can be tuned and alternative ways of damping the response.

In some embodiments according to the present disclosure, a number of pocket or blind hole features 24, 26 are added to the attachment region of the blade 14 thereby reducing both mass and stiffness. It should be noted, that these features 24, 26 could be located in the compressive stress region of the attachment 20 below min thickness region 28 above the dovetail root 20. This could help to avoid stress risers from the features and maintain a load path through continuous fibers from the airfoil 22 to the attachment root 20. Additionally, the shape and location of the features 24, 26 may be chosen to minimize the disruption of fibers from airfoil 22 to the attachment root 20.

Another potential benefit of these pocket features 24, 26 could be that if tooled and made in the forming of the component is that they effectively reduce the thickness of the part and improve processing quality via chemical vapor infiltration (CVI), silicon infiltration (SI), and/or melt infiltration (MI).

In some embodiments of the disclosed design, an isolation layer/shim 40 could be thin and fit between the flank faces of the CMC turbine blade 14 and the attachment faces of the disk 12 to protect against material incompatibility. The isolation layer/shim 40 could be manufactured with a tab/stud feature (e.g. arms 44) extending from the shim 40 and would fit into one or more of the modal tuning features/pockets 24 to fix/retain the shim 40 in place during engine assembly and operation.

In some embodiments, a loose fitting material 46 may be placed in the pockets 26 and trapped (during assembly or other means) to stay in that location through engine running. This loose fitting material 46 would act as an additional damper. This material could be metallic or CMC. It could be a single piece or made of multiple small pieces placed in a single modal tuning cavity.

Of course the use of one or more of the features described herein is contemplated and not all features are required to obtain the potential benefits described. It is considered that various individual features or combinations of features disclosed may be incorporated and still fall within the scope of the disclosure.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A turbine wheel assembly adapted for use in a gas turbine engine, the assembly comprising
a disk configured for rotation about an engine axis and shaped to include a plurality of dovetail slots spaced about the periphery of the disk, and
a plurality of turbine blades comprising ceramic matrix composite materials, each of the turbine blades shaped to include an airfoil that extends radially away from the disk and a root with a dovetail shape that is received in one of the plurality of dovetail slots spaced about the periphery of the disk to couple the turbine blade to the disk for rotation with the disk, and
a plurality of platforms independent of the plurality of turbine blades that are coupled to the disk for rotation with the disk about the engine axis, the plurality of platforms configured to resist the movement of hot gases that interact with the airfoils of the plurality of turbine blades from moving radially-inwardly toward interaction with the roots of the plurality of turbine blades,
wherein each of the plurality of turbine blades is shaped so that the root with the dovetail shape of each turbine blade includes pockets formed therein at a location radially inward of a minimum thickness section of the root to allow for adjustment of the natural frequency of the turbine blade away from undesired modes.

2. The assembly of claim 1, wherein the pockets include face pockets formed in an axially-facing forward surface of the root and in an axially-facing aft surface of the root.

3. The assembly of claim 2, further comprising a plurality of isolation shims configured to discourage material interaction between the plurality of turbine blades and the disk at the point of loading along the root during rotation of the turbine wheel assembly about the engine axis.

4. The assembly of claim 3, wherein the plurality of isolation shims include primary panels arranged to interface between radially-outwardly facing load surfaces of the root and radially-inwardly facing load surfaces of the disk that define the dovetail slots and retention arms that extend into the pockets formed in the axially-facing forward surface of the root and the axially-facing aft surface of the root.

5. The assembly of claim 1, wherein the pockets include side pockets formed in at least partially radially-outwardly facing load surfaces of the root.

6. The assembly of claim 5, further comprising a plurality of loose fill pieces each arranged in one of the side pockets for movement relative to the plurality of turbine blades.

7. The assembly of claim 6, wherein each of the side pockets are shaped to extend at least in part radially-outwardly from an opening in the radially-outwardly facing load surfaces of the root so as to encourage movement of the plurality of loose fill pieces into contact with the root upon rotation of the turbine wheel assembly about the engine axis.

8. The assembly of claim 6, further comprising a plurality of isolation shims configured to discourage material interaction between the plurality of turbine blades and the disk at the point of loading along the root during rotation of the turbine wheel assembly about the engine axis.

9. The assembly of claim 8, wherein the plurality of isolation shims include primary panels arranged to interface between the radially-outwardly facing load surfaces of the root and radially-inwardly facing load surfaces of the disk that define the dovetail slots, and wherein the primary panels block movement of the plurality of loose fill pieces out of the side pockets.

10. The assembly of claim 9, wherein the pockets include face pockets formed in an axially-facing forward surface of the root and in an axially-facing aft surface of the root, and wherein the plurality of isolation shims include retention arms that extend into the face pockets to retain the primary panels in place relative to the plurality of turbine blades.

11. A turbine wheel assembly adapted for use in a gas turbine engine, the assembly comprising
a disk configured for rotation about an engine axis and shaped to include a plurality of slots spaced about the periphery of the disk, and
a plurality of turbine blades comprising ceramic matrix composite materials, each of the turbine blades shaped to include an airfoil that extends radially away from the disk and a root that is received in one of the plurality of slots spaced about the periphery of the disk to couple the turbine blade to the disk for rotation with the disk, and
a plurality of platforms independent of the plurality of turbine blades that are coupled to the disk for rotation with the disk about the engine axis,
wherein each of the plurality of turbine blades is shaped so that the root of each turbine blade includes pockets formed therein at a location radially inward of a minimum thickness section of the root.

12. The assembly of claim 11, wherein the pockets include face pockets formed in at least one of an axially-facing forward surface of the root and in an axially-facing aft surface of the root.

13. The assembly of claim 12, further comprising a plurality of isolation shims located between the plurality of turbine blades and the disk at a point of radial loading along the root during rotation of the turbine wheel assembly about the engine axis.

14. The assembly of claim 13, wherein the plurality of isolation shims includes (i) primary panels arranged to interface between radially-outwardly facing load surfaces of the root and radially-inwardly facing load surfaces of the disk and (ii) retention arms that extend into the face pockets formed in the root.

15. The assembly of claim 11, wherein the pockets include side pockets formed in at least partially radially-outwardly facing load surfaces of the root.

16. The assembly of claim 15, further comprising a plurality of loose fill pieces each arranged in one of the side pockets for movement relative to the plurality of turbine blades.

17. The assembly of claim 16, wherein each of the side pockets are shaped to extend, at least in part, radially-outwardly from an opening into the root so as to encourage movement of the plurality of loose fill pieces radially outwardly upon rotation of the turbine wheel assembly about the engine axis.

18. The assembly of claim 16, further comprising a plurality of isolation shims located between the plurality of turbine blades and the disk at the point of radial loading along the root during rotation of the turbine wheel assembly about the engine axis.

19. The assembly of claim 18, wherein the plurality of isolation shims include primary panels that interface between the root and the disk, and wherein the primary panels block movement of the plurality of loose fill pieces out of the side pockets.

20. The assembly of claim 19, wherein the pockets include face pockets formed in an axially-facing forward surface of the root and in an axially-facing aft surface of the root, and wherein the plurality of isolation shims include retention arms that extend into the face pockets.
